(19) United States
(12) Patent Application Publication
(10) Pub. No.: US 2007/0177966 A1
(43) Pub. Date: Aug. 2, 2007

(54) Adjustable covers for a liftgate assembly

(75) Inventor: Mikko Niinisto, Stow, OH (US)

Correspondence Address: BROUSE MCDOWELL LPA, 388 SOUTH MAIN STREET, SUITE 500, AKRON, OH, 44311, US

(73) Assignee: WALTCO TRUCK EQUIPMENT COMPANY

(21) Appl. No.: 11/344,916

(22) Filed: Feb. 1, 2006

(51) Int. Cl. B60P 1/00

(52) U.S. Cl. 414/557; 414/917

(57) ABSTRACT

A liftgate assembly may include: a platform; a lift assembly for use in lifting the platform; and, a bed extension. The bed extension may include: (a) a traffic surface adapted to receive traffic for loading and unloading cargo; (b) first and second openings; and, (c) first and second covers selectively movable by first and second portions, respectively, of the lift assembly from a first position covering the first and second openings to a second position where the first and second portions of the lift assembly extend through the first and second openings, respectively.

### I. BACKGROUND OF THE INVENTION

A. Field of Invention

This invention pertains to the art of methods and apparatuses regarding liftgates and more specifically to methods and apparatuses regarding the raising of a liftgate platform with respect to a liftgate bed extension.

B. Description of the Related Art

It is well known in the art to attach liftgates to vehicle trailers or other forms of vehicle cargo holds to assist with loading and unloading of the vehicles. In general, liftgates include a platform or deck and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, and rail type liftgates. It is common with fold-up liftgates to use a bed extension or extension plate to bridge the gap or space between the platform and the vehicle bed when the liftgate is in the raised position. Other types of liftgates may also use a bed extension. The bed extension includes a traffic surface that, along with the platform and vehicle bed, is used to haul or carry cargo into and out of the vehicle.

A common problem in the art encountered especially, but not exclusively, with some fold-up liftgates, concerns potential interference between the bed extension and the lift assembly used to raise and lower the platform. More specifically, the lift assembly generally includes support arms pivotally attached at one end to a liftgate frame member and pivotally attached at the opposite end to the platform. The support arm ends connected to the platform preferably do not extend below the platform when in the lowered position so as not to contact the ground surface. However, to accomplish this requirement as well as all the desired range of motion requirements to move the platform between the folded position, the lowered position, and the raised position, many designs require that the support arm ends that connect to the platform extend above the level of the bed extension when in the raised position. This creates the problem of potential interference between the support arm ends and the bed extension.

One possible solution is to position the support arm ends outside the width of the bed extension. This solution is undesirable as there then would be an “open” area at each end of the bed extension making it more difficult to attach the bed extension to the vehicle and providing less available bed extension surface area when the platform is in the lowered position. Another potential solution known in the art is to provide “pockets” at each end of the bed extension. These pockets permit the support arm ends to extend upwardly but they prevent the ends of the bed extension from having an upper surface at the same level as the traffic surface. The pockets thus create a potential interference problem with the doors of the cargo hold if they open outwardly.

The present invention provides methods and apparatuses for permitting the support arm ends that connect to the platform to extend above the level of the bed extension when in the raised position yet without creating interference problem with the doors of the cargo hold. This invention thus overcomes the foregoing difficulties and others while providing better and more advantageous overall results.

### II. SUMMARY OF THE INVENTION

According one embodiment of this invention, a method includes the steps of: A. providing a liftgate assembly comprising: (a) a platform; (b) a lift assembly for use in lifting the platform; and (c) a bed extension having: (1) a traffic surface adapted to receive traffic for loading and unloading cargo; (2) a first opening; and, (3) a first cover for use in covering the first opening and movably connected to the bed extension; B. mounting the liftgate assembly to a vehicle; C. raising the platform with the lift assembly; and, D. contacting the first cover with a first portion of the lift assembly and thereby moving the first cover in a first direction relative to the bed extension.

According to another embodiment of this invention, the step of moving the first cover in a first direction relative to the bed extension, includes the step of extending the first portion of the liftgate through the first opening and above a plane defined by the traffic surface of the bed extension.

According to another embodiment of this invention, the step of moving the first cover in a first direction relative to the bed extension, includes the step of extending a portion of the first cover above the plane defined by the traffic surface of the bed extension.

According to another embodiment of this invention, prior to the step of contacting the first cover with a first portion of the lift assembly, the method includes the step of positioning the first cover so that no portion of the first cover extends above a plane defined by the traffic surface of the bed extension.

According to another embodiment of this invention, a liftgate assembly may include: a platform; a lift assembly for use in lifting the platform; and, a bed extension including: (a) a traffic surface adapted to receive traffic for loading and unloading cargo; (b) a first opening; and, (c) a first cover selectively movable by a first portion of the lift assembly from a first position covering the first opening to a second position where the first portion of the lift assembly extends through the first opening.

According to another embodiment of this invention, the first cover is pivotally connected to the bed extension.

According to another embodiment of this invention, the first cover is slidably connected to the bed extension.

According to still another embodiment of this invention, the bed extension may have two openings positioned on opposite ends of the bed extension.

One advantage of this invention is that portions of the lift assembly can selectively extend through openings in the bed extension when the liftgate platform is raised.

Another advantage of this invention is that when the liftgate platform is not in the raised position, the openings in the bed extension are covered.

Still another advantage of this invention is that the adjustable covers do not create any interference problems with the doors of the cargo hold.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective side view of a liftgate shown in the folded position.

FIG. 2 is a perspective side view of a portion of a vehicle that may receive a liftgate according to this invention.

FIG. 3 is a perspective side view of the liftgate shown in FIG. 1 but shown in the lowered position.

FIG. 4 is a perspective side view of the liftgate shown in FIG. 1 shown in the raised condition.

FIG. 5 is a side perspective view similar to that shown in FIG. 4 but from a different angle.

FIG. 6 is a side view of the liftgate shown in FIG. 4.

FIG. 7 is a side view of the liftgate similar to that shown in FIG. 4 but illustrating another embodiment for the covers.

FIG. 8 is a side perspective view similar to that shown in FIG. 5 but illustrating the embodiment shown in FIG. 7.

FIG. 9 is a side view of the liftgate similar to that shown in FIG. 6 but illustrating the embodiment shown in FIG. 7.

### IV. DETAILED DESCRIPTION OF THE INVENTION

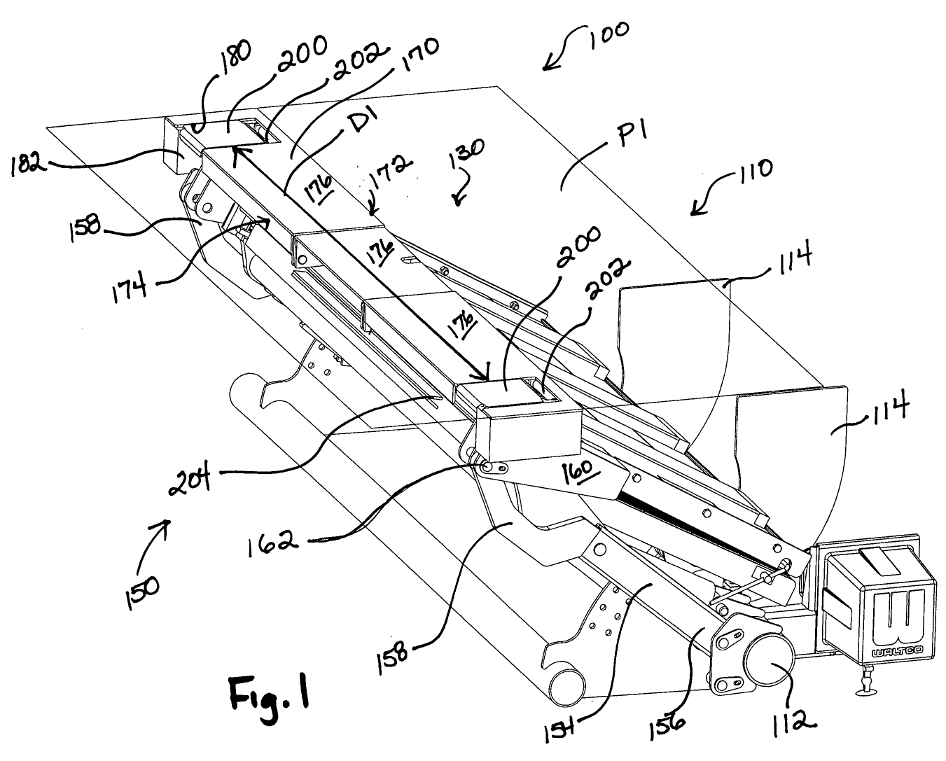

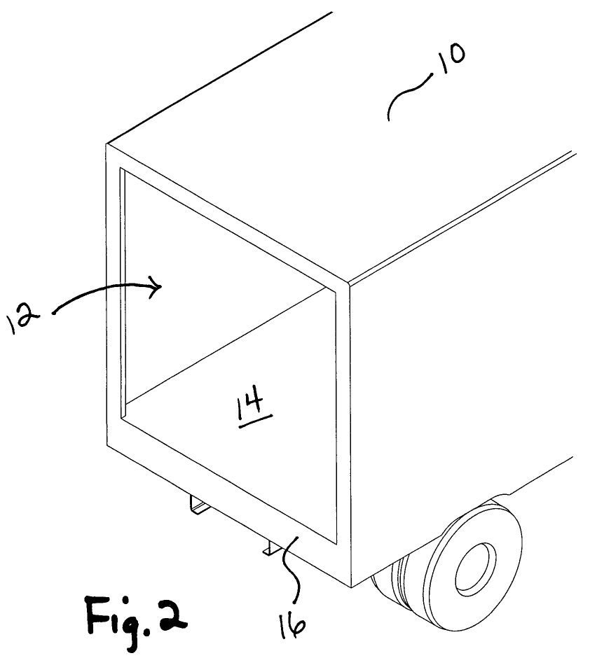

Referring now to the drawings wherein the showings are for purposes of illustrating embodiments of the invention only and not for purposes of limiting the same, FIG. 1 shows a liftgate assembly 100 including at least one cover 200 (two shown) according to this invention. While the liftgate assembly 100 shown is the style known as flip-a-way or fold-up, it is to be noted that this invention will work with any liftgate style, type and size, when applied with sound engineering judgment. The liftgate assembly 100 may be mounted to a vehicle 10, such as shown in FIG. 2, having a cargo hold 12 with a vehicle bed 14. The vehicle 10 may also have a sill 16 at the outer edge of the cargo hold 12 and conventional vehicle frame members (not shown) to which the liftgate assembly 100 may be attached to the vehicle 10 in any conventional manner. Any type and style of vehicle will work well with this invention when applied with sound engineering judgment.

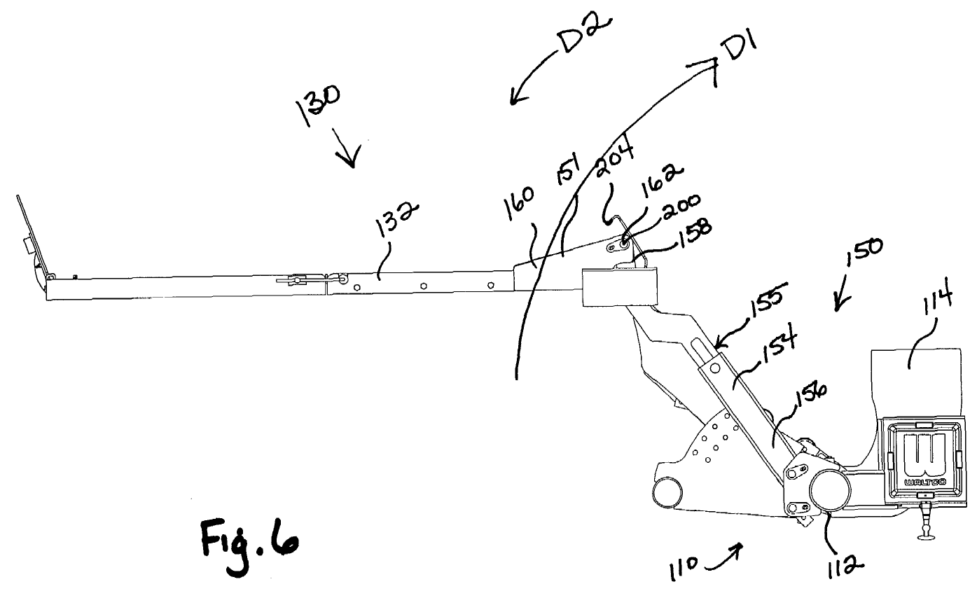

With reference now to FIGS. 1 and 3-6, the liftgate assembly 100 may include a mount assembly 110, a platform assembly 130 including a platform or deck 132, a lift assembly 150 and a bed extension 170. The mount assembly 110 may include one or more mounting tubes 112 and one or more mounting plates 114 as well as other components shown but not referenced. The mount assembly 110 is used to mount the liftgate assembly 100 to the vehicle frame in any convention manner and thus will not be described in detail.

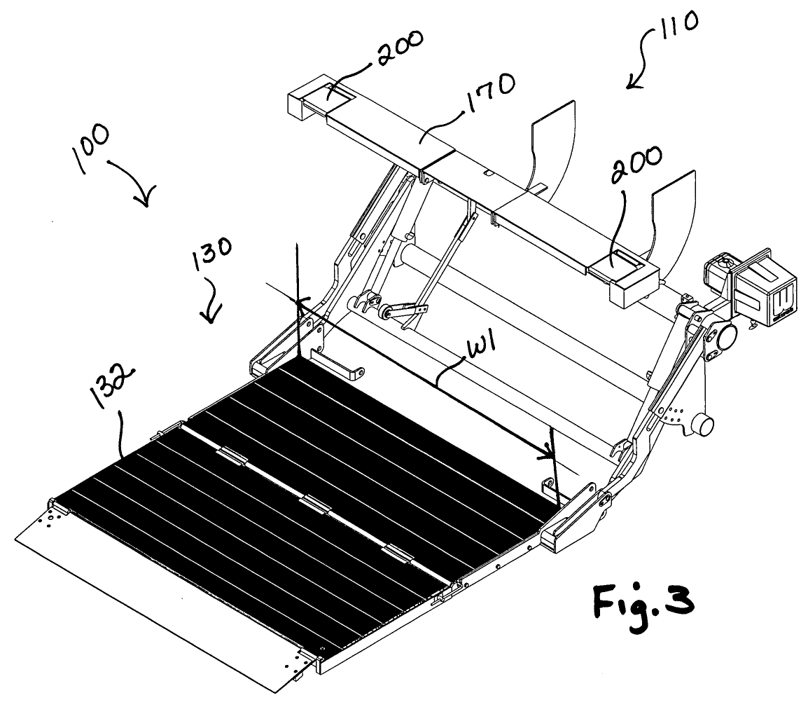

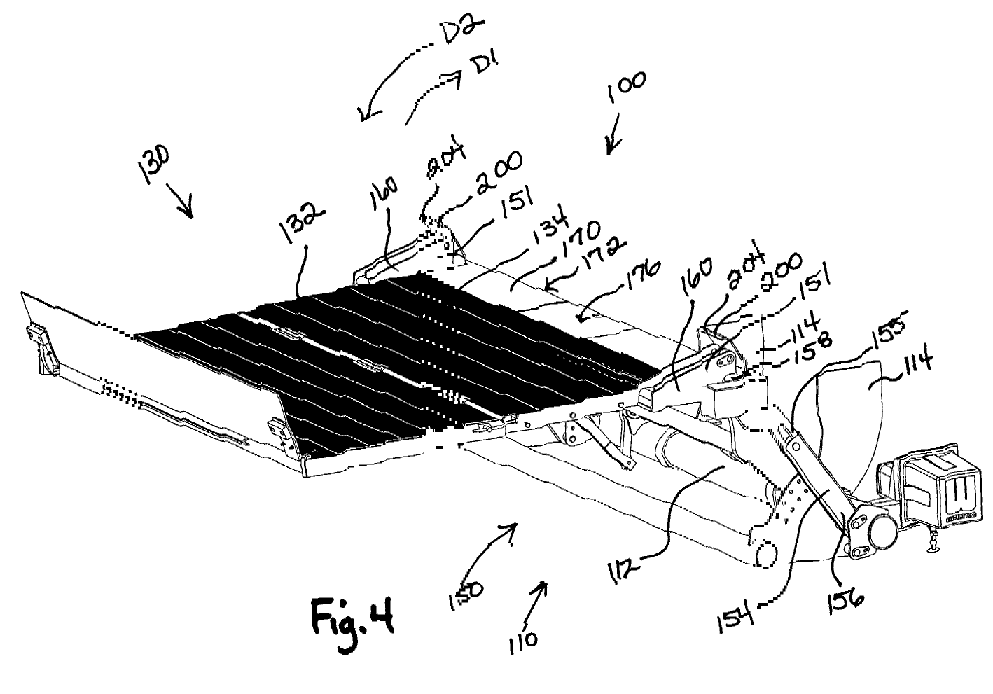

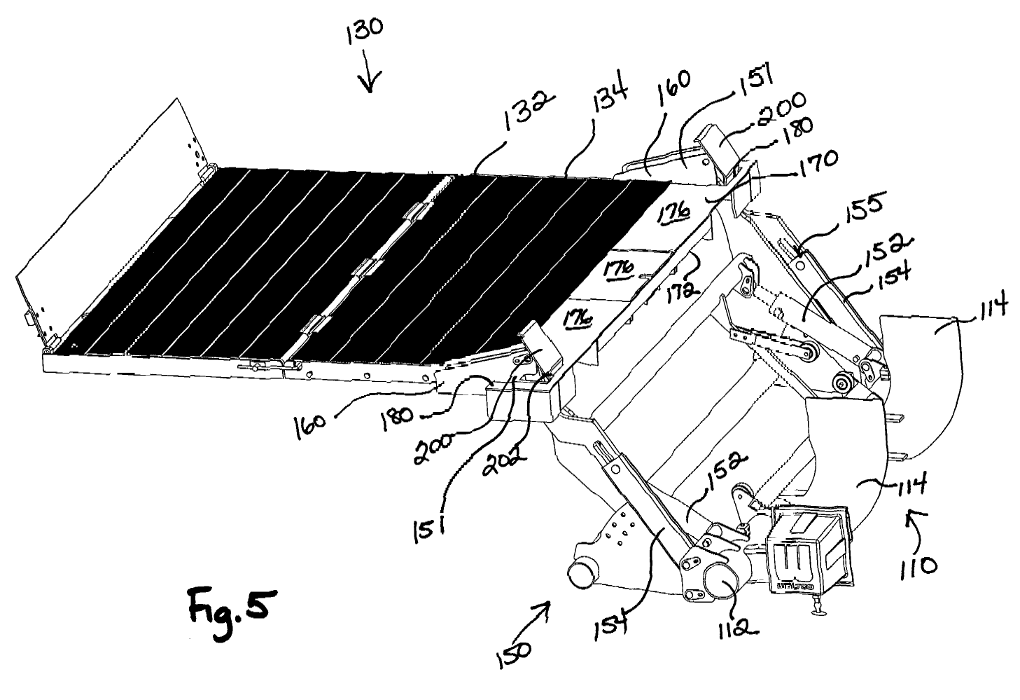

With continuing reference to FIGS. 1 and 3-6, the lift assembly 150 is used to move the platform 132 between a folded or closed position (shown in FIG. 1), a lowered position (shown in FIG. 3) and a raised position (shown in FIG. 4). The lift assembly 150 may include a control system (not shown) and a hydraulic system (not shown) used to operate one or more cylinders 152 (two shown in FIG. 5) to move the platform 132. The basic operation of the control and hydraulic systems are well known and will not be described in detail. The lift assembly 150 may also include a pair of support arms 154, 154, operatively attached at first ends 156, 156 to a liftgate frame member (such as mounting tube 112 as shown) and operatively attached at second ends 158, 158 to the platform 132. While the particular types of attachments between each support arm 154, 154 and the frame member and platform 132 can vary according to need, in the embodiments shown, each attachment includes pivotal motion to permit the range of motion shown. However, any type of attachment will work with this invention. Each support arm 154 in one embodiment may include an expanding mechanism 155, such as a telescoping arrangement, that permits the length of the support arm 154 to be adjusted during the motion of the platform 132. An expanding mechanism 155 is optional with this invention. According to another embodiment, a pair of bracket members 160, 160 are fixedly attached (such as by welding) to opposite sides of the platform 132, as shown. A pivot pin 162 permits each second end 158 to pivot with respect to each bracket member 160.

With reference now to FIGS. 1-6, the bed extension 170 may have a first side 172 adapted to abut the vehicle 10, such as along the sill 16, and a second side 174 adapted to abut a first end 134 of the platform 132, as shown. The first end 134 of the platform 132 may have a width W1 (shown in FIG. 3). The bed extension 170 may also have a traffic surface 176 adapted to receive traffic for loading and unloading cargo. A pair of covers 200, 200 are used to cover a corresponding pair of openings 180, 180 defined in the bed extension 170, as shown. In one embodiment, the openings 180, 180 are positioned on opposite ends of the bed extension 170. In the embodiment shown, each opening 180 is defined in part by a gap 182 (shown in FIG. 1) formed in the second side 174 of the bed extension 170. This embodiment permits a portion of each bracket member 160 to extend through the corresponding opening 180 (described further below) and also permits each bracket member 160 to extend beyond the opening 180 through the gap 182, as shown. The bracket members 160, 160 may thus be sized larger than the openings 180, 180, if desired. In one embodiment, the distance D1 (shown in FIG. 1) between the inner most edges of the openings 180, 180 is at least equal to the platform width W1. This permits the traffic surface 176 to have a length equal to the width W1 of the platform 132, as shown.

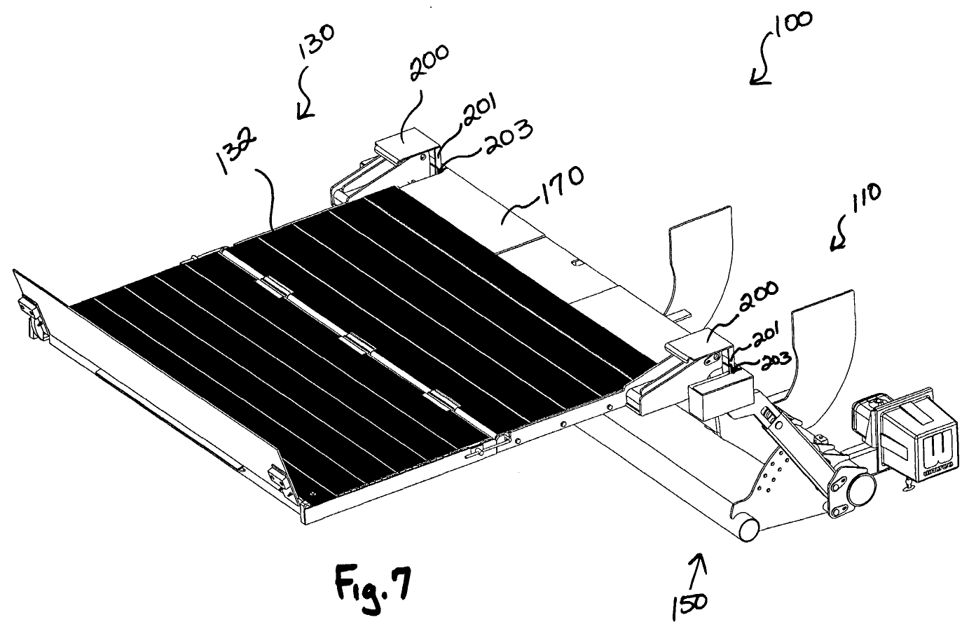

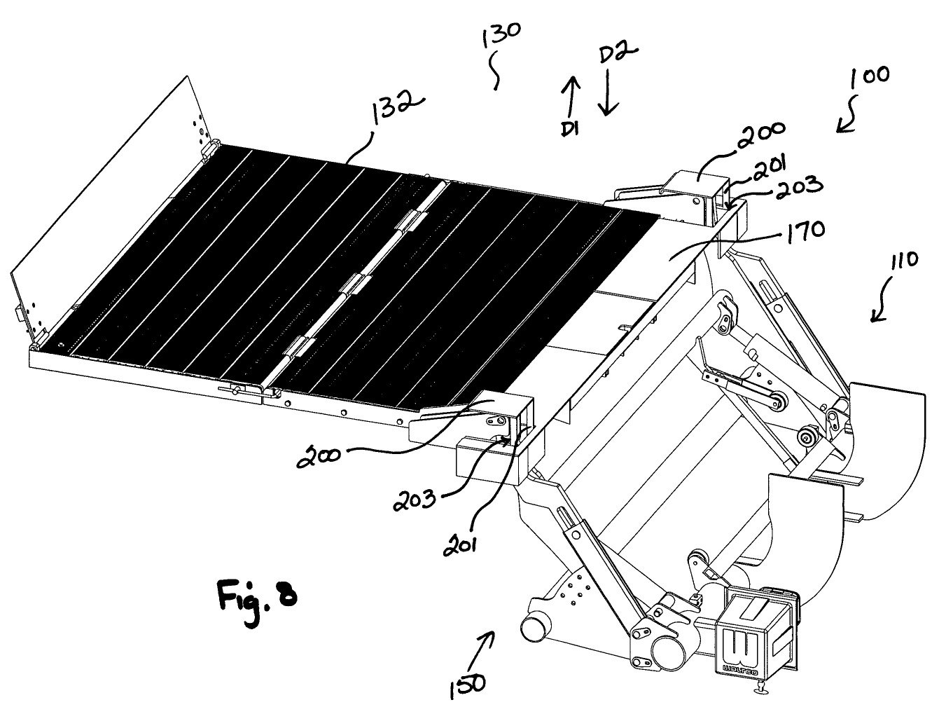

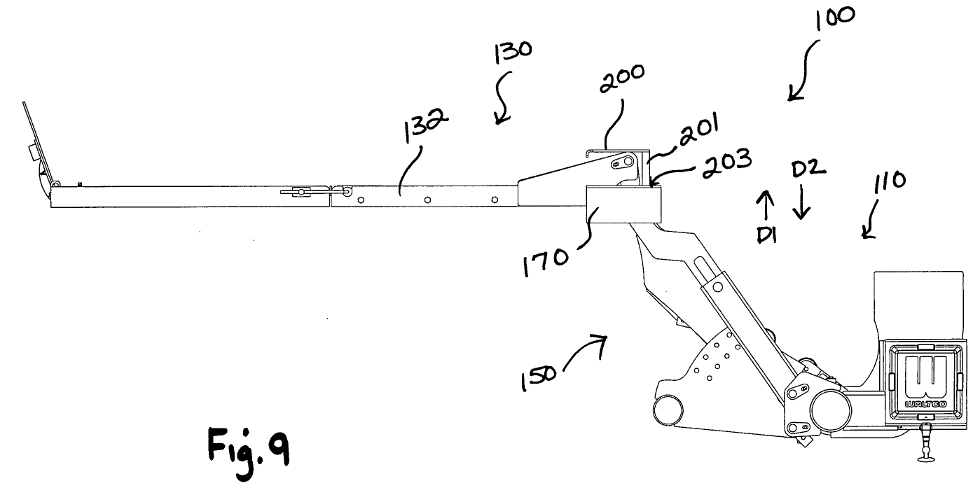

With reference now to FIGS. 4-9, each cover 200 is moveable with respect to the corresponding opening 180 for purposes to be described further below. In one embodiment, shown in FIGS. 4-6, each cover 200 is pivotally attached to the bed extension 170 with a pivot pin or hinge connection 202. In another embodiment, shown in FIGS. 7-9 each cover 200 is slidably attached to the bed extension 170. The slidable attachment may include a pair of columns 201, 201 on opposite sides of the cover 200 that are slidably received in channels 203, 203 as shown. It is to be understood that any manner of moving each cover 200 away from the corresponding opening 180 will work well with this invention if chosen according to sound engineering principles. Each cover 200 may have a first end 204 used to cover the corresponding gap 182, as shown.

With reference now to FIGS. 1-9, the operation of this invention will now be described. First, the lift assembly 150 is mounted to vehicle 10 as described above. Then, the platform 132 is placed into the lowered position shown in FIG. 3. In the embodiments shown, note that no portion of either cover 200, 200 extends above a plane P1 (referenced in FIG. 1) defined by the traffic surface 176 of the bed extension 170. This provides for an even overall top surface for the bed extension 170. Next, the control system is activated to begin raising the platform 132. As the platform 132 is being raised, a portion 151, 151 of the lift assembly 150 comes into contact with a bottom surface of each cover 200, 200. For the embodiment shown, the particular portions 151, 151 that contact the covers 200, 200 include a portion of each bracket member 160 where the second end 158 of each support arm 154 is pivotally connected. However, it is important to note that any portion of the lift assembly 150 can be used with this invention. As the lift assembly portions 151, 151 contact the covers 200, 200, the covers move in a first direction D1 to uncover the openings 180, 180. As noted above, this movement may be accomplished by pivoting the covers 200, 200 (as illustrated in FIGS. 4-6), sliding the covers 200, 200 (as illustrated in FIGS. 7-9) or other motion of the covers 200, 200. This movement permits the portions 151, 151 to extend upward through the openings 180, 180, as shown in FIG. 4. With the portions 151, 151 extended as just described, they also may extend above the plane P1 defined by the traffic surface 176. The covers 200, 200 also may extend above the plane P1. When it is no longer desired to keep the platform 132 at the raised position, the control system is activated to begin lowering the platform 132. As the platform 132 begins to lower, the portions 151, 151 of the lift assembly 150 move downward correspondingly. This permits the covers 200, 200 to move in second direction D2, whether by pivoting, sliding or other motion. As the platform 132 continues to move downward, the portions 151, 151 move out of contact with the covers 200, 200. The covers 200, 200 thus return to the position shown in FIG. 1 where no portion of the either cover 200, 200 extends above the plane P1.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A method comprising the steps of:
providing a liftgate assembly comprising: (a) a platform; (b) a lift assembly for use in lifting the platform; and (c) a bed extension having: (1) a traffic surface adapted to receive traffic for loading and unloading cargo; (2) a first opening; and, (3) a first cover for use in covering the first opening and movably connected to the bed extension;
mounting the liftgate assembly to a vehicle;
raising the platform with the lift assembly; and,
contacting the first cover with a first portion of the lift assembly and thereby moving the first cover in a first direction relative to the bed extension.

2. The method of claim 1 wherein the step of, moving the first cover in a first direction relative to the bed extension, comprises the step of:
extending the first portion of the liftgate through the first opening and above a plane defined by the traffic surface of the bed extension.

3. The method of claim 2 wherein the step of, moving the first cover in a first direction relative to the bed extension, further comprises the step of:
extending a portion of the first cover above the plane defined by the traffic surface of the bed extension.

4. The method of claim 1 wherein prior to the step of, contacting the first cover with a first portion of the lift assembly, the method comprises the step of:
positioning the first cover so that no portion of the first cover extends above a plane defined by the traffic surface of the bed extension.

5. The method of claim 1 wherein the step of, moving the first cover in a first direction relative to the bed extension, comprises the step of:
pivoting the first cover in the first direction relative to the bed extension.

6. The method of claim 1 wherein the step of, moving the first cover in a first direction relative to the bed extension, comprises the step of:
sliding the first cover in the first direction relative to the bed extension.

7. The method of claim 1 further comprising the steps of:
lowering the platform with the lift assembly; and,
moving the first portion of the lift assembly in contact with the first cover away from the first cover thereby moving the first cover in a second direction relative to the bed extension.

8. The method of claim 7 wherein the step of, moving the first cover in a second direction relative to the bed extension, comprises the step of:
positioning the first cover so that no portion of the first cover extends above a plane defined by the traffic surface of the bed extension.

9. The method of claim 1 further comprising the steps of:
providing the bed extension with a second opening and a second cover for use in coving the second opening, the second cover being movably connected to the bed extension; and,
wherein after the step of raising the platform with the lift assembly, the method further comprises the step of contacting the second cover with a second portion of the lift assembly and thereby moving the second cover in the first direction relative to the bed extension.

10. A liftgate assembly comprising:
a platform;
a lift assembly for use in lifting the platform; and,
a bed extension comprising:
(a) a traffic surface adapted to receive traffic for loading and unloading cargo;
(b) a first opening; and,
(c) a first cover selectively movable by a first portion of the lift assembly from a first position covering the first opening to a second position where the first portion of the lift assembly extends through the first opening.

11. The liftgate assembly of claim 10 wherein when in the first position, no portion of the first cover extends above a plane defined by the traffic surface of the bed extension.

12. The liftgate assembly of claim 10 wherein when in the second position, a portion of the first cover extends above a plane defined by the traffic surface of the bed extension.

13. The liftgate assembly of claim 10 wherein the first cover is pivotally connected to the bed extension.

14. The liftgate assembly of claim 10 wherein the first cover is slidably connected to the bed extension.

15. The liftgate assembly of claim 10 wherein the bed extension has a first side adapted to abut a vehicle and a second side adapted to abut the platform, the second side having a first gap partially defining the first opening.

16. The liftgate assembly of claim 15 wherein the first cover has a first end that substantially covers the first gap when the first cover is in the first position.

17. A liftgate assembly comprising:
a platform;
a lift assembly for use in lifting the platform; and,
a bed extension comprising:
(a) a traffic surface adapted to receive traffic for loading and unloading cargo;
(b) first and second openings; and,
(c) first and second covers selectively movable by first and second portions, respectively, of the lift assembly from a first position covering the first and second openings to a second position where the first and second portions of the lift assembly extend through the first and second openings, respectively.

18. The liftgate assembly of claim 17 wherein the first opening is positioned on one end of the bed extension and the second opening is positioned on the opposite end of the bed extension.

19. The liftgate assembly of claim 18 wherein:
the bed extension has a first side adapted to abut a vehicle and a second side adapted to abut the platform;
the platform has a first end with a first width W1 adapted to abut the second side of the bed extension;
the distance between the inner most edges of the first and second openings is at least W1.
